(19) United States
(12) Patent Application Publication
(10) Pub. No.: US 2020/0148879 A1
(43) Pub. Date: May 14, 2020

(54) OPAQUE OXYGEN SCAVENGING CONTAINERS

(71) Applicant: GRAHAM PACKAGING COMPANY, L.P., Lancaster, PA (US)

(72) Inventors: Murali K. Akkapeddi, Norcross, GA (US); Brian K. Lynch, Merrimack, NH (US)

(21) Appl. No.: 16/681,319

(22) Filed: Nov. 12, 2019

Related U.S. Application Data
(60) Provisional application No. 62/760,623, filed on Nov. 13, 2018.

(51) Int. Cl. C08L 67/02; B65D 1/02; B65D 81/26

(52) U.S. Cl. CPC C08L 67/02; B65D 1/0207; C08L 2203/10; C08L 2205/035; C08L 2201/10; B65D 81/266

(57) ABSTRACT

A wall for a package comprising a composition wherein the composition comprises: a polyester base polymer; a polyolefin polymer; a functionalized polyolefin polymer selected from the group consisting of a maleic anhdride-grafted polypropylene, a maleic anhydride-grafted polypropylene adhesive resin, an acrylic acid-grafted polyproylene, a maleic anhydride-grafted styrene-ethylene-butylene-styrene copolymer, an ethylene-butyl acrylate-maleic anhydride terpolymer, an ethylene-butyl acrylate-glycidyl methacrylate terpolymer, an oxidized polyethylene wax, and mixtures thereof; an oxidizable polyether-based additive; and a transition metal catalyst.

### CROSS-REFERENCE TO RELATED APPLICATIONS

This application claim priority under 35 U.S.C. § 119(e) to U.S. provisional patent application No. 62/760,623, filed on Nov. 13, 2018, the entirety of which is incorporated herein by reference.

### BACKGROUND OF THE INVENTION

The present invention relates to stretch-blow-molded polyester containers that are opaque. In particular, the present invention relates to stretch-blow-molded opaque polyester containers that have superior barrier properties for oxygen, carbon dioxide, and visible light.

All references, including publications, patent applications, and patents, cited herein are hereby incorporated by reference to the same extent as if each reference were individually and specifically indicated to be incorporated by reference and were set forth in its entirety herein.

It is well known that oxygen-sensitive food products such as tomato-based ketchups and sauces, and beverage products such as orange juice, beer, and green tea, require a packaging material that has either high oxygen barrier properties or the ability to block any oxygen ingress so as to preserve the freshness and flavor of the packaged contents. Dairy products such as milk or even non-dairy products such as soy milk are not only sensitive to oxygen but also light.

For example, vitamins found in milk, such as B2 (riboflavin), B6, and B12, can oxidize or otherwise become unstable during processing and storage, which can contribute to a decrease in the nutritional quality of milk, as well as dairy products derived therefrom. Additionally, the secondary degradation of lipids can result in off-flavours, usually referred to as creating a “light-affected taste.” Oxygen and/or radiation with wavelengths ranging from 350 to 520 nm appear to be responsible for the degradation of these vitamins and also therefore for the impairment in the taste of the product.

Consequently, storage containers or the packaging for these containers must have an extremely low light transmission for both oxygen and radiation, including ultraviolet (UV) radiation and visible radiation. This specification becomes increasingly important as the storage time of the milk is extended, as in ultra-high temperature treatment (UHT) milk. Accordingly, numerous approaches have been undertaken in an effort to protect packaged dairy products from these rays.

A variety of additives have been integrated into plastic-packaging materials in an attempt to block or absorb UV radiation. Unfortunately, the transparency of the container is often sacrificed. Additionally, the product may develop an opacity or color from their use.

The most commonly used pigment for blocking UV light is the white pigment titanium dioxide. Unfortunately, the transparency of the container is often impaired. Indeed, the presence of titanium dioxide in an amount as low as 2-10 wt % yields opaque white plastic materials. The resulting color of the container is also quite dull, making it undesirable to the consumer.

Thus, there is a need for light barrier compositions that can be manufactured in a form that exhibits an appealing visual appearance, that are cost efficient, and that ultimately result in a lighter container in the manufacturing process of oxygen and light barrier packaging materials and other articles for oxygen sensitive products. These needs and other needs are satisfied by the present invention.

### BRIEF SUMMARY OF THE INVENTION

In one aspect, disclosed herein is a wall for a container comprising a composition wherein the composition comprises: a polyester base polymer; a polyolefin polymer; a functionalized polyolefin polymer selected from the group consisting of a maleic anhdride-grafted polypropylene, a maleic anhydride-grafted polypropylene adhesive resin, an acrylic acid-grafted polyproylene, a maleic anhydride-grafted styrene-ethylene-butylene-styrene copolymer, an ethylene-butyl acrylate-maleic anhydride terpolymer, an ethylene-butyl acrylate-glycidyl methacrylate terpolymer, an oxidized polyethylene wax, and mixtures thereof; an oxidizable polyether-based additive; and a transition metal catalyst.

In another aspect, disclosed herein is a wall for a container comprising a composition wherein the composition comprises: a polyester base polymer; from about 5 wt. % to about 15 wt. % of a polyolefin polymer; from about 0.1 wt. % to about 1.5 wt. % of a functionalized polyolefin polymer selected from the group consisting of a maleic anhdride-grafted polypropylene, a maleic anhydride-grafted polypropylene adhesive resin, an acrylic acid-grafted polyproylene, a maleic anhydride-grafted styrene-ethylene-butylene-styrene copolymer, an ethylene-butyl acrylate-maleic anhydride terpolymer, an ethylene-butyl acrylate-glycidyl methacrylate terpolymer, an oxidized polyethylene wax, and mixtures thereof; from about 0.5 wt. % to about 5 wt. % of an oxidizable polyether-based additive; a transition metal catalyst; and from about 1 wt. % to about 3 wt. % of a colorant such as, for example, TiO₂.

In another aspect, disclosed herein is a wall for a container comprising a composition wherein the composition comprises: a polyester base polymer; a polyolefin polymer; an oxidizable polyether-based additive; and a transition metal catalyst, wherein the container has an opacity of at least 90%, and wherein the oxidizable polyether-based additive functions as an oxygen scavenger and a compatibilizer which improves mechanical properties of the container by at least 10% greater than a reference container comprising a polyester base polymer and a polyolefin polymer without the polyether-based additive and having an opacity of at least 90%.

In yet another aspect, disclosed herein is a method for making a container having improved mechanical properties, the method comprising the steps of: a) melt-mixing a composition comprising a polyester base polymer, a polyolefin polymer, an oxidizable poly ether-based additive, and a transition metal catalyst; and b) forming a container, wherein the container has an opacity of at least 90%, and wherein the container exhibits mechanical properties at least 10% greater than a reference container comprising a polyester base polymer and a polyolefin polymer without the polyether-based additive, wherein the reference container also has an opacity of at least 90%.

### BRIEF DESCRIPTION OF THE DRAWINGS

FIG. 1 is a graph illustrating the oxygen scavenging performance of the opaque oxygen scavenging PET bottles disclosed herein vs the control ex. (clear bottles w/OS additive-1 but no PP) & comparative example (opaque bottle w/no OS additive 1).

### DETAILED DESCRIPTION OF THE INVENTION

The present disclosure can be understood more readily by reference to the following detailed description of the invention and the Examples included therein.

Embodiments disclosed herein include compositions that are useful in the manufacture of packaging (i.e., containers) for oxygen-sensitive materials that also benefit from the protection from light. In some embodiments, the composition includes a polyester base polymer; a polyolefin polymer; a functionalized polyolefin polymer selected from the group consisting of a maleic anhdride-grafted polypropylene, a maleic anhydride-grafted polypropylene adhesive resin, an acrylic acid-grafted polyproylene, a maleic anhydride-grafted styrene-ethylene-butylene-styrene copolymer, an ethylene-butyl acrylate-maleic anhydride terpolymer, an ethylene-butyl acrylate-glycidyl methacrylate terpolymer, an oxidized polyethylene wax, and mixtures thereof; an oxidizable polyether-based additive; and a transition metal catalyst.

In other embodiments, the composition includes a polyester base polymer; a polyolefin polymer; an oxidizable polyether-based additive; and a transition metal catalyst, wherein the container produced has an opacity of at least 90%, and wherein the oxidizable polyether-based additive functions as an oxygen scavenger and a compatibilizer which improves mechanical properties of the container by at least 10% greater than a reference container comprising a polyester base polymer and a polyolefin polymer without the polyether-based additive and having an opacity of at least 90%.

Compostions employed to form a wall of a container comprise at least the following components.

### 1) Polyester Base Polymer

The compositions disclosed herein and employed to form a wall of a container comprise a polyester base polymer. In preferred embodiments, the base polymer is polyethylene terephthalate.

Examples of suitable polyester polymers include polyethylene terephthalate homopolymers and copolymers of polyethylene terephthalate modified with one or more polycarboxylic acid modifiers and hydroxyl compound modifiers (collectively, “PET”), polyethylene naphthalate homopolymers and copolymers of polyethylene naphthalate modified with one or more polycarboxylic acid modifiers and hydroxyl compound modifiers (“PEN”), and blends of PET and PEN. A suitable PET or PEN polymer may include the one or more polycarboxylic acid modifiers in a cumulative amount of less than about 15 mole %, or less than about 10 mole %, or less than about 8 mole %. A suitable PET or PEN polymer may include the one or more hydroxyl compound modifiers in an amount of less than about 60 mole %, or less than about 50 mole %, or less than about 40 mole %, or less than about 15 mole %, or less than about 10 mole %, or less than about 8 mole %. A modifier polycarboxylic acid compound or hydroxyl compound is a compound other than the compound contained in an amount of at least about 85 mole %. The preferred polyester polymer is polyalkylene terephthalate, and most preferred is PET. In some embodiments, the polyester polymer contains at least about 90 mole % ethylene terephthalate repeat units, and in other embodiments, at least about 92 mole %, and in yet other embodiments at least about 94 mole %, based on the moles of all repeat units in the polyester polymers.

In addition to a diacid component of terephthalic acid, derivatives of terephthalic acid, naphthalene-2,6-dicarboxylic acid, derivatives of naphthalene-2,6-dicarboxylic acid, or mixtures thereof, the polycarboxylic acid component(s) of the present polyester may include one or more additional modifier polycarboxylic acids. Such additional modifier polycarboxylic acids include aromatic dicarboxylic acids preferably having about 8 to about 14 carbon atoms, aliphatic dicarboxylic acids preferably having about 4 to about 12 carbon atoms, or cycloaliphatic dicarboxylic acids preferably having about 8 to about 12 carbon atoms.

Examples of modifier dicarboxylic acids useful as an acid component(s) are phthalic acid, isophthalic acid, naphthalene-2,6-dicarboxylic acid, cyclohexanedicarboxylic acid, cyclohexanediacetic acid, diphenyl-4,4′-dicarboxylic acid, succinic acid, glutaric acid, adipic acid, azelaic acid, sebacic acid, and the like, with isophthalic acid, naphthalene-2,6-dicarboxylic acid, and cyclohexanedicarboxylic acid being most preferable. It should be understood that use of the corresponding acid anhydrides, esters, and acid chlorides of these acids is included in the term “polycarboxylic acid.” It is also possible for trifunctional and higher order polycarboxylic acids to modify the polyester.

The hydroxyl component is made from compounds containing 2 or more hydroxyl groups capable of reacting with a carboxylic acid group. In some preferred embodiments, preferred hydroxyl compounds contain 2 or 3 hydroxyl groups. Certain preferred embodiments have 2 hydroxyl groups. These hydroxyl compounds include C₂-C₄ alkane diols, such as ethylene glycol, propane diol, and butane diol, among which ethylene glycol is most preferred for container applications. In addition to these diols, other modifier hydroxyl compound component(s) may include diols such as cycloaliphatic diols preferably having 6 to 20 carbon atoms and/or aliphatic diols preferably having about 3 to about 20 carbon atoms. Examples of such diols include diethylene glycol; triethylene glycol; 1,4-cyclohexanedimethanol; propane-1,3-diol and butane-1,4-diol (which are considered modifier diols if ethylene glycol residues are present in the polymer in an amount of at least 85 mole % based on the moles of all hydroxyl compound residues); pentane-1,5-diol; hexane-1,6-diol; 3-methylpentanediol-(2,4); neopentyl glycol; 2-methylpentanediol-(1,4); 2,2,4-trimethylpentane-diol-(1,3); 2,5-ethylhexanediol-(1,3); 2,2-diethyl propane-diol-(1,3); hexanediol-(1,3); 1,4-di-(hydroxyethoxy)-benzene; 2,2-bis-(4-hydroxycyclohexyl)-propane; 2,4-dihydroxy-1,1,3,3-tetramethyl-cyclobutane; 2,2-bis-(3-hydroxyethoxyphenyl)-propane; and 2,2-bis-(4-hydroxypropoxyphenyl)-propane. Typically, polyesters such as polyethylene terephthalate are made by reacting a glycol with a dicarboxylic acid as the free acid or its dimethyl ester to produce an ester monomer and/or oligomers, which are then polycondensed to produce the polyester.

In some preferred embodiments, modifiers include isophthalic acid, naphthalenic dicarboxylic acid, trimellitic anhydride, pyromellitic dianhydride, 1,4-cyclohexane dimethanol, and diethylene glycol. The amount of the polyester polymer in the formulated polyester polymer composition ranges from greater than about 50.0 wt. %, or greater than about 80.0 wt. %, or greater than about 90.0 wt. %, or greater than about 95.0 wt. %, or greater than about 96.0 wt. %, or greater than about 97.0 wt. %, and up to about 99.90 wt. %, based on the weight of the composition. The polyester polymer compositions may also include blends of formulated polyester polymer compositions with other thermoplastic polymers such as polycarbonate. In some preferred compositions, the polyester comprises a majority of the composition of the inventions, and in some embodiments the polyester is present in an amount of at least about 80 wt. %, or at least about 90 wt. %, based on the weight of the composition (including the oxidizable polyether-based additive and a transition metal salt, but excluding fillers, inorganic compounds or particles, fibers, impact modifiers, or other polymers which serve as impact modifiers or which form a discontinuous phase such as may be found in cold storage food trays).

In some embodiments, the polyester base polymer is substantially free of antimony. As used herein, the term “substantially free of antimony” refers to polyester base polymers including less than about 100 ppm of antimony, preferably less than about 50 ppm, more preferably less than about 10 ppm, and most preferably from about 0 ppm to about 2 ppm. It is also preferable that the base polymer is substantially free of phosphorus. As used herein, the term “substantially free of phosphorus” refers to polyester base polymers including less than about 20 ppm of phosphorus, preferably less than about 10 ppm, more preferably less than about 5 ppm, and most preferably the polyester base polymer includes about 0 ppm to about 1 ppm. PET polymers formed using typical antimony metal-based catalysts typically contain about 190 ppm to about 300 ppm antimony and about 20 ppm to about 100 ppm of phosphorus.

In an exemplary embodiment, the antimony-free polyester base polymer is selected from PET resins formed using titanium, germanium, or aluminum metal-based catalysts. In some embodiments, the polyester base polymer may include a blend of a low-antimony or substantially antimony-free polyester base polymer and a polyester base polymer having a greater concentration of antimony, so long as the blend has an antimony concentration below the limits described above. Examples of preferred antimony-free PET resins are selected from titanium catalyst-based PET resins such as Laser+® HS Ti 818, W Ti 844 and the aluminum catalyst-based PET resins such as Laser+® B92A (formerly Parastar 7000) available from DAK America. The polyester base polymer may preferably have an intrisic viscosity (IV) ranging from about 0.5 dl/g to about 1.0 dl/g, more preferably from about 0.65 dl/g to about 0.9 dl/g and most preferably from about 0.72 dl/g to about 0.84 dl/g.

In a further aspect, PET is present in an amount of at least about 60 wt % based on the weight of the composition. In a still further aspect, PET is present in an amount of at least about 70 wt % based on the weight of the composition. In yet a further aspect, PET is present in an amount of at least about 80 wt % based on the weight of the composition. In an even further aspect, PET is present in an amount of at least about 85 wt % based on the weight of the composition. In a still further aspect, PET is present in an amount of at least about 90 wt % based on the weight of the composition. In yet a further aspect, PET is present in an amount of at least about 95 wt % based on the weight of the composition. In an even further aspect, PET is present in an amount of at least about 97 wt % based on the weight of the composition.

In some embodiments, the PET (or polyester base polymer) comprises an added transition metal such as, for example, cobalt, wherein the transition metal functions to promote or catalyze the oxidation of an oxidizable component such as, for example, those disclosed below to create an active oxygen scavenging component. An example of a commercially available PET with added cobalt is Indorama 2512 (w/60 ppm Co) available from Indorama Corporation.

### 2) Polyolefin Polymer

The compositions disclosed herein and employed to form a wall of a container comprise a polyolefin polymer (also referred to herein as a “polyolefin”). In preferred embodiments, the polyolefin polymer is polpropylene.

The polyolefins of the composition may be linear, but may optionally contain side chains such as are found, for instance, in conventional, low-density polyethylene. The polyolefin may be a homopolymer or a copolymer of an aliphatic monoolefin, preferably having about 2 to 6 carbon atoms. Examples of polyolefins include, but are not limited to, polyethylene, low-density polyethylene, high-density polyethylene, cross-linked high-density polyethylene, polystyrene, polypropylene, polypropylene copolymer, polymethyl pentene, polyvinyl chloride, polybutylene, polymethylpentene, and polytetrafluoroethylene. Thus, in various aspects, the polyolefin is selected from polyethylene, polypropylene, and polybutylene. In a further aspect, the polyolefin is polypropylene.

In certain aspects, the polyolefin is incompatible with PET. Exemplary incompatible polyolefins include, but are not limited to, poly(4-methyl-1-pentene), polyethylene, polypropylene, and polystyrene. In a further aspect, the incompatible polyolefin has a density less than 1.0 g/cm³ In a still further aspect, the incompatible polyolefin has a melting point of less than 140° C. In yet a further aspect, the incompatible polyolefin has a melting point of less than 135° C. In an even further aspect, the incompatible polyolefin has a melting point of about 130° C.

In certain aspects, the polyolefin is of a narrow molecular weight distribution. The molecular weight distribution of a polymer is defined by the ratio of the weight average molecular weight (Mw) and the number average molecular weight (Mn) wherein the minimum possible ratio of 1.0 defines the polymer having all the chains the same size. Suitable polyolefins for the composition of the invention may have a number average molecular weight of from about 10,000 to about 400,000, preferably of from about 30,000 to about 50,000 and a ratio of from about 1 to about 9 preferably of from about 2 to about 6, as determined by conventional gel permeation chromatography.

In a further aspect, the polyolefin is present in an amount of from about 1 wt. % to about 15 wt. % based on the weight of the composition. In a still further aspect, the polyolefin is present in an amount of from about 2.5 wt. % to about 15 wt. % based on the weight of the composition. In yet a further aspect, the polyolefin is present in an amount of from about 5 wt. % to about 15 wt. % based on the weight of the composition. In an even further aspect, the polyolefin is present in an amount of from about 7.5 wt. % to about 15 wt. % based on the weight of the composition. In a still further aspect, the polyolefin is present in an amount of from about 10 wt. % to about 15 wt. % based on the weight of the composition. In yet a further aspect, the polyolefin is present in an amount of from about 1 wt. % to about 12.5 wt. % based on the weight of the composition. In an even further aspect, the polyolefin is present in an amount of from about 1 wt. % to about 10 wt. % based on the weight of the composition. In a still further aspect, the polyolefin is present in an amount of from about 1 wt. % to about 7.5 wt. % based on the weight of the composition. In yet a further aspect, the polyolefin is present in an amount of from about 1 wt. % to about 5 wt. % based on the weight of the composition. In an even further aspect, the polyolefin is present in an amount of from about 2.5 wt. % to about 12.5 wt. % based on the weight of the composition. In a still further aspect, the polyolefin is present in an amount of from about 5 wt. % to about 10 wt. % based on the weight of the composition.

The polyolefin is imiscible in the polyester base polymer (major component) and, thus, functions in the present compositions to impart an opacity to the container wall when formed, preferably by a stretch blow molding process. By “opacity,” it is meant that the presence of the polyolefin immiscible in and dispersed throughout the polyester base polymer blocks the passage of radiant energy and especially light. Thus, the disclosed compositions form light barrier containers and are advantageously highly light scattering and, accordingly, can be useful in the preparation of, for example, the packaging of dairy products.

In one aspect, the transmittance through the container wall is less than about 1.5% at a wavelength of from about 400 nm to about 700 nm. In a still further aspect, the transmittance is less than about 1.5% at a wavelength of from about 450 nm to about 700 nm. In yet a further aspect, the transmittance is less than about 1.5% at a wavelength of from about 500 nm to about 700 nm. In an even further aspect, the transmittance is less than about 1.5% at a wavelength of from about 400 nm to about 650 nm. In a still further aspect, the transmittance is less than about 1.5% at a wavelength of from about 400 nm to about 600 nm. In yet a further aspect, the transmittance is less than about 1.5% at a wavelength of from about 500 nm to about 600 nm.

In a further aspect, the transmittance is less than about 1.0% at a wavelength of from about 400 nm to about 700 nm. In a still further aspect, the transmittance is less than about 1.0% at a wavelength of from about 450 nm to about 700 nm. In yet a further aspect, the transmittance is less than about 1.0% at a wavelength of from about 500 nm to about 700 nm. In an even further aspect, the transmittance is less than about 1.0% at a wavelength of from about 400 nm to about 650 nm. In a still further aspect, the transmittance is less than about 1.0% at a wavelength of from about 500 nm to about 600 nm.

In a further aspect, the transmittance is less than about 0.5% at a wavelength of from about 400 nm to about 700 nm. In a still further aspect, the transmittance is less than about 0.5% at a wavelength of from about 450 nm to about 700 nm. In yet a further aspect, the transmittance is less than about 0.5% at a wavelength of from about 500 nm to about 700 nm. In an even further aspect, the transmittance is less than about 0.5% at a wavelength of from about 400 nm to about 650 nm. In a still further aspect, the transmittance is less than about 0.5% at a wavelength of from about 400 nm to about 600 nm. In yet a further aspect, the transmittance is less than about 0.5% at a wavelength of from about 500 nm to about 600 nm.

### 3) Functionalized Polyolefin Polymer

The compositions disclosed herein and employed to form a wall of a container comprise a functionalized polyolefin polymer. As used herein, the term “functionalized polyolefin polymer” refers to a polyolefin that has been modified to yield at least one substituent having a polar group such as, for example, an oxygen-containing group (e.g., hydroxyl, ethylene oxide, propylene oxide, carboxyl, etc.). Examples of such functionalized polyolefin polymers include maleic anhydride-grafted low molecular weight (Mn=3900) polypropylene, maleic anhydrid-grafted polypropylene adhesive resin (e.g., Borcoat BB 122E-LT, Borealis Polymers), acrylic acid-grafted polypropylene (e.g., Polybond 1001N, Addivant Corporation), maleic anhydride-grafted styrene-ethylene-butylene-styrene (S-EB-S) copolymers (e.g., Kraton FG1901x, Kraton Corporation), ethylene-butyl acrylate-maleic anhydride terpolymers (e.g., Lotador 3210, Arkema), ethylene-butyl acrylate-glycidyl methacrylate terpolymers (e.g., Lotador AX8840, Arkema), and oxidized polyethylene wax (e.g., AC325, Honeywell). More than one functionalized polyolefin polymer can be employed.

The functionalized polyolefin polymer functions as a processing aid and a compatablizer between the polyester base polymer and the polyolefin and, as such, improves the dispersibility of the polyolefin in the polyester base polymer to increase the opacity for a given amount of polyolefin and also improves the mechanical properties of the finished container.

As a compatibilizer, the functionalized polyolefin polymer improves at least one mechanical property of the finished container such as, for example, tensile strength, load, elongation, creep, drop impact resistance, and the like, by at least 10% greater as compared to a reference container comprising a polyester base polymer (e.g., PET) and a polyolefin (e.g., polypropylene) without the functionalized polyolefin polymer, wherein both the container and the reference container also has an opacity of at least 90%.

Preferably, the functionalized polyolefin polymer improves at least one mechanical property of the finished container such as, for example, tensile strength, load, elongation, creep, drop impact resistance, and the like, by at least 20% greater as compared to a reference container comprising a polyester base polymer (e.g., PET) and a polyolefin (e.g., polypropylene) without the functionalized polyolefin polymer, wherein both the container and the reference container also has an opacity of at least 90%. Preferably, the functionalized polyolefin polymer improves at least one mechanical property of the finished container such as, for example, tensile strength, load, elongation, creep, drop impact resistance, and the like, by at least 30% greater as compared to a reference container comprising a polyester base polymer (e.g., PET) and a polyolefin (e.g., polypropylene) without the functionalized polyolefin polymer, wherein both the container and the reference container also has an opacity of at least 90%. Preferably, the functionalized polyolefin polymer improves at least one mechanical property of the finished container such as, for example, tensile strength, load, elongation, creep, drop impact resistance, and the like, by at least 40% greater as compared to a reference container comprising a polyester base polymer (e.g., PET) and a polyolefin (e.g., polypropylene) without the functionalized polyolefin polymer, wherein both the container and the reference container also has an opacity of at least 90%. Preferably, the functionalized polyolefin polymer improves at least one mechanical property of the finished container such as, for example, tensile strength, load, elongation, creep, drop impact resistance, and the like, by at least 50% greater as compared to a reference container comprising a polyester base polymer (e.g., PET) and a polyolefin (e.g., polypropylene) without the functionalized polyolefin polymer, wherein both the container and the reference container also has an opacity of at least 90%. Preferably, the functionalized polyolefin polymer improves at least one mechanical property of the finished container such as, for example, tensile strength, load, elongation, creep, drop impact resistance, and the like, by at least 60% greater as compared to a reference container comprising a polyester base polymer (e.g., PET) and a polyolefin (e.g., polypropylene) without the functionalized polyolefin polymer, wherein both the container and the reference container also has an opacity of at least 90%. Preferably, the functionalized polyolefin polymer improves at least one mechanical property of the finished container such as, for example, tensile strength, load, elongation, creep, drop impact resistance, and the like, by at least 70% greater as compared to a reference container comprising a polyester base polymer (e.g., PET) and a polyolefin (e.g., polypropylene) without the functionalized polyolefin polymer, wherein both the container and the reference container also has an opacity of at least 90%. Preferably, the functionalized polyolefin polymer improves at least one mechanical property of the finished container such as, for example, tensile strength, load, elongation, creep, drop impact resistance, and the like, by at least 80% greater as compared to a reference container comprising a polyester base polymer (e.g., PET) and a polyolefin (e.g., polypropylene) without the functionalized polyolefin polymer, wherein both the container and the reference container also has an opacity of at least 90%.

Preferably, the amount of functionalized polyolefin polymer included in the compositions disclosed herein is from about 0.1 wt. % to about 1.5 wt. %, preferably from about 0.3 wt. % to about 1.0 wt. % and, still more preferably from about 0.4 wt. % to about 0.7 wt. % based on the weight of the composition. In some embodiments, the amount of functionalized polyolefin polymer in the composition is about 0.5 wt. % based on the weight of the composition.

### 4) Oxidizable Polyether-Based Additive

In preferred embodiments, the oxidizable polyether-based additive is at least one compound having the general structure of:

X—[R—O]ₙ—R′—Y,

wherein R is a substituted or unsubstituted alkylene chain having from 2 to 10 carbon atoms (such as ethylene, propylene, butylene, 1,4-tetramethylene, etc.);

n ranges from 4 to 100;

X and Y are selected from H, OH, —OCOR₁ groups, —OCOAr₁, —O_{R}, and —OAr₁ groups, where R₁ is an alkyl group (such as methyl, ethyl, propyl and so on up to C18) and Ar is an aryl group (such as an unsubstituted or substituted phenyl, naphthyl, etc.); and

R′ may be the same as R or selected from the group consisting of —[COR₂COOR₃O]ₚ— and —[COAr₂COOR₃O]ₚ—, wherein Ar₂ is a phenylene or naphthylene group, R₂ and R₃ are C₂ to C₁₈ alkylene groups, and p ranges from 10 to 100.

As used herein, the term “alkyl” refers to a substituted or unsubstituted aliphatic hydrocarbon chain. Alkyl groups have straight and branched chains. In some embodiments, alkyls have from 1 to 12 carbon atoms or 1 to 6 carbon atoms, unless explicitly specified otherwise. Alkyl groups include, but are not limited to methyl, ethyl, propyl, isopropyl, butyl, 1-butyl and t-butyl. Specifically included within the definition of “alkyl” are those aliphatic hydrocarbon chains that are optionally substituted.

As used herein, the term “aryl” is defined herein as an aromatic carbocyclic moiety of up to 20 carbon atoms. In some embodiments, aryl groups have 6-20 carbon atoms or 6-14 carbon atoms. Aryls may be a single ring (monocyclic) or multiple rings (bicyclic, up to three rings) fused together or linked covalently. Any suitable ring position of the aryl moiety may be covalently linked to the defined chemical structure. Aryl groups include, but are not limited to, phenyl, 1-naphthyl, 2-naphthyl, dihydronaphthyl, tetrahydronaphthyl, biphenyl, anthryl, phenanthryl, fluorenyl, indanyl, biphenylenyl, acenaphthenyl, and acenaphthylenyl. In some embodiments, phenyl is a preferred aryl. Aryl groups may also be optionally substituted with one or more substituents.

Optional substituents for alkyl, alkenyl, or aryl groups are well known to those skilled in the art. These substituents include alkyl, alkoxy, aryloxy, hydroxy, acetyl, cyano, nitro, glyceryl, and carbohydrate, or two substituents taken together may be linked as an alkylene group to form a ring.

The oxidizable polyether-based additive functions—in cooperation with a transition metal in the positive oxidation state—to actively react with oxygen passing through the container wall to thus prevent the oxygen from oxidizing the contents of the container.

The oxidizable polyether-based additive also functions as a processing aid and a compatablizer between the polyester base polymer and the polyolefin and, as such, improves the dispersibility of the polyolefin in the polyester base polymer to increase the opacity for a given amount of polyolefin and also improves the mechanical properties of the finished container.

As a compatibilizer, the oxidizable polyether-based additive improves at least one mechanical property of the finished container such as, for example, tensile strength, load, elongation, creep, drop impact resistance, and the like, by at least 10% greater as compared to a reference container comprising a polyester base polymer (e.g., PET) and a polyolefin (e.g., polypropylene) without the oxidizable polyether-based additive, wherein both the container and the reference container also has an opacity of at least 90%.

Preferably, the oxidizable polyether-based additive improves at least one mechanical property of the finished container such as, for example, tensile strength, load, elongation, creep, drop impact resistance, and the like, by at least 10% greater as compared to a reference container comprising a polyester base polymer (e.g., PET) and a polyolefin (e.g., polypropylene) without the oxidizable polyether-based additive, wherein both the container and the reference container also has an opacity of at least 90%. Preferably, the oxidizable polyether-based additive improves at least one mechanical property of the finished container such as, for example, tensile strength, load, elongation, creep, drop impact resistance, and the like, by at least 20% greater as compared to a reference container comprising a polyester base polymer (e.g., PET) and a polyolefin (e.g., polypropylene) without the oxidizable polyether-based additive, wherein both the container and the reference container also has an opacity of at least 90%. Preferably, the oxidizable polyether-based additive improves at least one mechanical property of the finished container such as, for example, tensile strength, load, elongation, creep, drop impact resistance, and the like, by at least 30% greater as compared to a reference container comprising a polyester base polymer (e.g., PET) and a polyolefin (e.g., polypropylene) without the oxidizable polyether-based additive, wherein both the container and the reference container also has an opacity of at least 90%. Preferably, the oxidizable polyether-based additive improves at least one mechanical property of the finished container such as, for example, tensile strength, load, elongation, creep, drop impact resistance, and the like, by at least 40% greater as compared to a reference container comprising a polyester base polymer (e.g., PET) and a polyolefin (e.g., polypropylene) without the oxidizable polyether-based additive, wherein both the container and the reference container also has an opacity of at least 90%. Preferably, the oxidizable polyether-based additive improves at least one mechanical property of the finished container such as, for example, tensile strength, load, elongation, creep, drop impact resistance, and the like, by at least 50% greater as compared to a reference container comprising a polyester base polymer (e.g., PET) and a polyolefin (e.g., polypropylene) without the oxidizable polyether-based additive, wherein both the container and the reference container also has an opacity of at least 90%. Preferably, the oxidizable polyether-based additive improves at least one mechanical property of the finished container such as, for example, tensile strength, load, elongation, creep, drop impact resistance, and the like, by at least 60% greater as compared to a reference container comprising a polyester base polymer (e.g., PET) and a polyolefin (e.g., polypropylene) without the oxidizable polyether-based additive, wherein both the container and the reference container also has an opacity of at least 90%. Preferably, the oxidizable polyether-based additive improves at least one mechanical property of the finished container such as, for example, tensile strength, load, elongation, creep, drop impact resistance, and the like, by at least 70% greater as compared to a reference container comprising a polyester base polymer (e.g., PET) and a polyolefin (e.g., polypropylene) without the oxidizable polyether-based additive, wherein both the container and the reference container also has an opacity of at least 90%. Preferably, the oxidizable polyether-based additive improves at least one mechanical property of the finished container such as, for example, tensile strength, load, elongation, creep, drop impact resistance, and the like, by at least 80% greater as compared to a reference container comprising a polyester base polymer (e.g., PET) and a polyolefin (e.g., polypropylene) without the oxidizable polyether-based additive, wherein both the container and the reference container also has an opacity of at least 90%.

The preferred oxidizable polyether based additives are selected from:
(1) polyether diols (also known as polyols) such as polyethylene glycol, polypropylene glycol, polytetramethylene ether glycol (PTMEG), of which PTMEG is preferred;
(2) ester end-capped derivatives of polyether diols (i.e., ∝,ω-polyether diesters), of which PTMEG diesters are preferred, and PTMEG dibenzoate or dioctaoate are most preferred;
(3) polyether-polyester block copolymers such as PTMEG-b-PET, PTMEG-b-PBT copolymers, of which PTMEG-b-PET copolymer in which the PTMG content is at least 40 wt. % is preferred; and
(4) ether end-capped derivatives of polyetherdiols (e.g., ∝,ω-polyether diethers) of which PTMEG diethers are preferred, and PTMEG-∝,ω-dimethyl ether or PTMEG-∝,ω-diethyl ether are the most preferred.

In an embodiment where a PET container such as a bottle is made from the composition, the oxidizable polyether-based additive may include up to about 5 wt. % of the bottle, preferably at least 0.5 wt. %. For example, an exemplary bottle may include about 1 wt. % of the oxidizable polyether-based additive. If the bottle is a monolayer bottle having a single wall made of the composition, the composition may include up to about 2 wt. % of the oxidizable polyether-based additive, preferably at least about 0.5 wt. %. For example, an exemplary monolayer bottle may include about 1 wt. % of the oxidizable polyether-based additive. In another example, if the bottle is a multilayer bottle having a single layer comprising the composition, the layer made of the composition may include at least 0.5 wt. %, and typically about 1 wt. % to about 5 wt. % (depending on the thickness of the layer), of the at least one oxidizable polyether-based additive, so that the polyether-based additive makes up at least 0.5 wt. % of the total weight of all the layers of the bottle.

### 5) Transition Metal

The instant compositions include as an oxidation catalyst a transition metal salt including a metal in a positive oxidation state. It should be noted that it is contemplated that one or more such metals may be used. The transition metal functions to catalyze or promote the oxidation of the organic oxidizable component (i.e., the reaction of the oxidizable polyether-based additive with molecular oxygen). The transition metal can be selected from the first, second, or third transition series of the Periodic Table. The metal can be Rh, Ru, or one of the elements in the series of Sc to Zn (i.e., Sc, V, Cr, Mn, Fe, Co, Ni, Cu, and Zn).

As detailed above, the transition metal may be delivered to the composition as part of the polyester base polymer composition. If not, the transition metal may be added to the composition as a transition metal salt. In some embodiments, for example, cobalt is added in +2 or +3 oxidation state. In some embodiments, it is preferred to use cobalt in the +2 oxidation state. In certain embodiments, copper in the +2 oxidation state is utilized. In some embodiments, rhodium in the +2 oxidation state is used. In certain embodiments, zinc may also be added to the composition. Preferred zinc compounds include those in a positive oxidation state.

Suitable counter-ions to the transition metal cations include carboxylates, such as neodecanoates, octanoates, acetates, lactates, naphthalates, malates, stearates, acetylacetonates, linoleates, oleates, palmitates, 2-ethylhexanoates, or ethylene glycolates; or as their oxides, borates, carbonates, chlorides, dioxides, hydroxides, nitrates, phosphates, sulfates, or silicates among others.

In a preferred embodiment, the transition metal catalyst is selected from any cobalt carboxylate salt, preferably cobalt salts of C₂ to C1₈ carboxylic acids. Most preferably, the transition metal catalyst is a pastille-form cobalt neodecanoate composed of a mixture of cobalt propionate and cobalt neodecanoate.

In some embodiments, the composition has a transitional metal concentration of about 20 ppm to about 400 ppm, preferably about 30 ppm to about 200 ppm, and most preferably about 50 ppm to about 100 ppm. The exact amount of transition metal used in an application can be determined by trials that are well within the skill level of one skilled in the art.

The transition metal or metals may be added neat or in a carrier (such as a liquid or wax) to an extruder or other device for making the article, or the metal may be present in a concentrate or carrier with the oxidizable organic component, in a concentrate or carrier with a base polymer, or in a concentrate or carrier with a blend of the base polymer and oxidizable polyether-based additive. Alternatively, at least a portion of the transition metal may be added as a polymerization catalyst to the melt phase reaction for making the base polymer (a polyester polymer in some embodiments) and be present as residual metals when the polymer is fed to the melting zone (e.g. the extrusion or injection molding zone) for making the article such as a preform or sheet. It is desirable that the addition of the transition metal does not substantially increase the IV of the melt in the melt processing zone. Thus, transition metal or metals may be added in two or more stages, such as once during the melt phase for the production of the polyester polymer and again once more to the melting zone for making the article.

The amounts of the components used in the oxygen scavenging formulations of the present invention can affect the use and effectiveness of this composition. Thus, the amounts of polyester base polymer, oxidizable polyether-based additive, and transition metal salt can vary depending on the desired article and its end use. For example, a primary function of the organic oxidizable components detailed above is to react irreversibly with oxygen during the scavenging process, while a primary function of the transition metal catalyst is to facilitate this process. Thus, to a large extent, the amount of the organic oxidizable component present affects the oxygen scavenging capacity of the composition, i.e., the amount of oxygen that the composition can consume, while the amount of transition metal catalyst affects the rate at which oxygen is consumed as well as the induction period.

### 6) Colorants/Pigments (Optional)

In various aspects, the compositions of the present invention optionally comprise a colorant. Examples of colorants include, but are not limited to, carbon black, grey colorant, amber colorant, blue colorant, white colorant, opaque colorant, translucent colorant, infrared absorbing colorant (e.g., carbon black or activated carbon), and highly reflective colorant (e.g., titanium dioxide). Thus, in various aspects, the colorant is selected from a white colorant, an opaque colorant, and a translucent colorant.

In a further aspect, the colorant is present in an amount of from about 0.01 wt. % to about 10 wt. % based on the weight of the composition. In a still further aspect, the colorant is present in an amount of from about 0.05 wt. % to about 10 wt. % based on the weight of the composition. In yet a further aspect, the colorant is present in an amount of from about 0.1 wt. % to about 10 wt. % based on the weight of the composition. In an even further aspect, the colorant is present in an amount of from about 0.5 wt. % to about 10 wt. % based on the weight of the composition. In a still further aspect, the colorant is present in an amount of from about 1 wt. % to about 10 wt. % based on the weight of the composition. In yet a further aspect, the colorant is present in an amount of from about 0.01 wt. % to about 7 wt. % based on the weight of the composition. In an even further aspect, the colorant is present in an amount of from about 0.01 wt. % to about 5 wt. % based on the weight of the composition. In a still further aspect, the colorant is present in an amount of from about 0.01 wt. % to about 3 wt. % based on the weight of the composition. In yet a further aspect, the colorant is present in an amount of from about 0.05 wt. % to about 7 wt. % based on the weight of the composition. In an even further aspect, the colorant is present in an amount of from about 0.1 wt. % to about 5 wt. % based on the weight of the composition. In a still further aspect, the colorant is present in an amount of from about 0.5 wt. % to about 5 wt. % based on the weight of the composition. In yet a further aspect, the colorant is present in an amount of from about 1 wt. % to about 3 wt. % based on the weight of the composition.

In a further aspect, the colorant comprises a calcium-based colorant. In a still further aspect, the colorant comprises a titanium-based colorant. In yet a further aspect, the colorant comprises titanium dioxide.

Other optional components can be added to the polymer blend composition to enhance the performance properties. For example, crystallization aids, impact modifiers, surface lubricants, denesting agents, stabilizers, antioxidants, ultraviolet light absorbing agents, metal deactivators (e.g., cobalt), colorants, nucleating agents, acetaldehyde reducing compounds, other reheat rate enhancing aids such as elemental antimony or reduced antimony, carbon black, graphite, black iron oxide, red iron oxide and the like, sticky bottle additives such as talc, and fillers and the like can be included. The resin may also contain small amounts of branching agents such as trifunctional or tetrafunctional comonomers such as trimellitic anhydride, trimethylol propane, pyromellitic dianhydride, pentaerythritol, and other polyester forming polyacids or polyols generally known in the art. All of these additives and many others and their use are well known in the art and do not require extensive discussion. Typically, the total quantity of such components will be less than about 10% by weight relative to the total composition. In some embodiments, the amount of these other optional components is less than about 5%, by weight relative to the total composition.

As used herein, the word “container” is synonymous with the word “package” or “packaging article” and may be used interchangeably. The compositions of the present disclosure can be incorporated in packaging articles having various forms. Suitable articles include, but are not limited to, flexible sheet films, flexible bags, pouches, semi-rigid and rigid containers such as bottles (e.g., PET bottles) or metal cans, or combinations thereof.

Typical flexible films and bags include those used to package various food items and may be made up of one or a multiplicity of layers to form the overall film or bag-like packaging material. The compositions of the present invention can be used in one, some or all of the layers of such packaging material.

Typical rigid or semi-rigid articles include plastic, paper or cardboard containers, such as those utilized for dairy products, juices, soft drinks, as well as thermoformed trays or cups normally having a thickness in the range of from about 100 micrometers to about 1000 micrometers. The walls of such articles can comprise single or multiple layers of materials. The articles can also take the form of a bottle or metal can, or a crown, cap, crown or cap liner, plastisol or gasket. The compositions of the present invention can be used as an integral layer or portion of, or as an external or internal coating or liner of, the formed semi-rigid or rigid packaging article. As a liner, the composition can be extruded as a film along with the rigid article itself, in, e.g., a coextrusion, extrusion coating, or extrusion lamination process, so as to form the liner in situ during article production; or alternatively can be adhered by heat and/or pressure, by adhesive, or by any other suitable method to an outer surface of the article after the article has been produced.

In one preferred embodiment of the present invention, the composition of the present invention, can be employed to form a monolayer bottle or container. In another preferred embodiment of the present invention, the composition of the present invention can form one layer of a multilayer bottle or container.

Besides articles applicable for packaging food and beverage, articles for packaging other light and oxygen-sensitive products can also benefit from the present invention. Such products would include pharmaceuticals, oxygen sensitive medical products, corrodible metals or products, electronic devices and the like.

The instant compositions can be made by mixing a polyester base polymer (PET, for example) with the polyolefin, the functionalized polyolefin, the oxidizable polyether-based additive and the transition metal catalyst (and colorant, if employed). Such compositions can be made by any method known to those skilled in the art. In certain embodiments, some or part of the transition metal of the transition metal catalyst may exist in the base polymer prior to mixing. This residual metal, for example, can exist from the manufacturing process of the base polymer or have been intentionally added. In some embodiments, the polyester base polymer (PET, for example) with the polyolefin, the functionalized polyolefin, the oxidizable polyether-based additive and the transition metal catalyst (and colorant, if employed) are mixed by tumbling in a hopper. Other optional ingredients can be added during this mixing process or added to the mixture after the aforementioned mixing or to an individual component prior to the aforementioned mixing step.

The instant composition can also be made by adding each ingredient separately and mixing the ingredients prior melt processing the composition to form an article. In some embodiments, the mixing can be just prior to the melt process zone. In other embodiments, one or more ingredients can be premixed in a separate step prior to bringing all of the ingredients together.

For example, and without limitation, PET, a polyolefin such as, for example, polypropylene, and a functionalized polyolefin can be combined in the melt processing zone as individual streams or as pellet/pellet dry blends, or as combinations thereof. In a yet further aspect, a blend comprising PET, a polyolefin such as, for example, polypropylene, and a functionalized polyolefin can be simultaneously dried in a drying zone, under conditions effective to at least partially remove moisture from the blend. In an apparatus containing a drying zone, radiant or convective heat, or electromagnetic or microwave radiation, or any other source for removal of moisture, is emitted from a drying zone or is passed through at least a portion of the mechanical drying zone and contacts the particle blend to remove at least a portion of surface and/or internal water moisture.

The wall may be a rigid one, a flexible sheet, or a clinging film. It may be homogenous or a laminate or coated with other polymers. If it is laminated or coated, then the scavenging property may reside in a layer of the wall the permeance of which is relatively high in the absence of scavenging and which alone would not perform very satisfactorily but which performs satisfactorily in combination with one or more other layers which have a relatively low permeance but negligible or insufficient oxygen-scavenging properties. A single such layer could be used on the outside of the package since this is the side from which oxygen primarily comes when the package is filled and sealed. However, such a layer to either side of the scavenging layer would reduce consumption of scavenging capacity prior to filling and sealing.

When the instant compositions are used in a wall or as a layer of a wall, the permeability of the composition for oxygen is advantageously not more than about 3.0, or not more than about 1.7, or not more than about 0.7, or not more than about 0.2, or not more than about 0.03 cm³ mm/(m² atm day). The permeability of the composition provided by the present invention is advantageously not more than about three-quarters of that in the absence of oxygen-scavenging properties. In some embodiments, the permeability is not more than about one half, one-tenth in certain embodiments, one twenty-fifth in other embodiments, and not more than one-hundredth in yet other embodiments of that in the absence of oxygen-scavenging properties. The permeability in the absence of oxygen-scavenging properties is advantageously not more than about 17, or not more than about 10, or not more than about 6 cm³ mm/(m² atm day). A particularly good effect can be achieved for such permeabilities in the range from about 0.5, or about 1.0, to 10, or about 6.0, cm³ mm/(m² atm day). Measuring oxygen permeation can be performed by one of ordinary skill in the art employing oxygen permeation (OTR) instrumentation such as, for example, OX-TRAN® instruments available from MOCON, Inc. (Minneapolis, Minn.).

The above-described permeabilities may be achieved without an induction period for embodiments where the polyester base polymer is substantially free of antimony and phosphorous, which, in practical terms means that such permeabilities are achievable immediately after the container is formed.

In another aspect, the instant composition can be used as a master batch for blending with other polymers. In such compositions, the concentration of the components detailed above will be higher to allow for the final blended product to have suitable amounts of these components. The master batch may also contain an amount of the polymer to which the master batch is to be blended with. In other embodiments, the master batch may contain a polymer that is compatible with the polymer to which the master batch is to be blended.

In yet another aspect, the compositions of the instant invention can be used for forming a layer of a wall which primarily provides oxygen-scavenging (another layer including polymer providing gas barrier without significant scavenging), or as a head-space scavenger (completely enclosed, together with the package contents, by a package wall). Such techniques are well known to those skilled in the art.

The time period for which the permeability is maintained can be extended by storing the articles in sealed containers or under an inert atmosphere such as nitrogen prior to use with oxygen sensitive materials.

In another aspect, the invention provides a package, whether rigid, semi-rigid, collapsible, lidded, or flexible or a combination of these, comprising a wall as formed from the compositions described herein. Such packages can be formed by methods well known to those skilled in the art.

In still another embodiment, the present disclosure provides a method for making a container having improved mechanical properties, the method comprising the steps of: a) melt-mixing a composition comprising a polyester base polymer, a polyolefin polymer, an oxidizable poly ether-based additive, and a transition metal catalyst; and b) forming a container, wherein the container has an opacity of at least 90%, and wherein the container exhibits mechanical properties at least 10% greater than a reference container comprising a polyester base polymer and a polyolefin polymer without the polyether-based additive, wherein the reference container also has an opacity of at least 90%.

Among the techniques that may be used to make articles are molding generally, injection molding, stretch blow molding, extrusion, thermoforming, extrusion blow molding, and (specifically for multilayer structures) co-extrusion and lamination using adhesive tie layers. Orientation, e.g., by stretch blow molding, of the polymer is especially attractive with phthalate polyesters because of the known mechanical advantages that result.

The melt processing zone for making the article can be operated under customary conditions effective for making the intended articles, such as preforms, bottles, trays, and other articles mentioned below. In one embodiment, such conditions are effective to process the melt without substantially increasing the IV of the melt and which are ineffective to promote transesterification reactions. In some preferred embodiments, suitable operating conditions effective to establish a physical blend of the polyester polymer, functionalized polyolefin polymer (if employed), oxidizable polyether-based additive, and transition metal catalyst are temperatures in the melt processing zone within a range of about 250° C. to about 300° C. at a total cycle time of less than about 6 minutes, and typically without the application of vacuum and under a positive pressure ranging from about 0 psig to about 900 psig. In some embodiments, the residence time of the melt on the screw can range from about 1 to about 4 minutes.

Specific articles include preforms, containers and films for packaging of food, beverages, cosmetics, pharmaceuticals, and personal care products where a high oxygen barrier is needed. Examples of beverage containers are bottles for holding water and carbonated soft drinks, and the invention is particularly useful in bottle applications containing juices, sport drinks, beer or any other beverage where oxygen detrimentally affects the flavor, fragrance, performance (prevent vitamin degradation), or color of the drink. The compositions of the instant invention are also particularly useful as a sheet for thermoforming into rigid packages and films for flexible structures. Rigid packages include food trays and lids. Examples of food tray applications include dual ovenable food trays, or cold storage food trays, both in the base container and in the lidding (whether a thermoformed lid or a film), where the freshness of the food contents can decay with the ingress of oxygen. The compositions of the instant invention also find use in the manufacture of cosmetic containers and containers for pharmaceuticals or medical devices.

The package walls of the instant invention can be a single layer or a multilayer construction. In some embodiments using multilayer walls, the outer and inner layers may be structural layers with one or more protective layers containing the oxygen scavenging material positioned there between. In some embodiments, the outer and inner layers comprise a polyolefin or a polyester. In certain embodiments, a single layer design is preferred. Such a layer may have advantages in simplicity of manufacture and cost.

In this specification and in the claims that follow, reference will be made to a number of terms, which shall be defined to have the following meanings:

As used herein, the phrase “having the formula” or “having the structure” is not intended to be limiting and is used in the same way that the term “comprising” is commonly used. The term “independently selected from” is used herein to indicate that the recited elements, e.g., R groups or the like, can be identical or different.

As used herein, the terms “a”, “an”, “the” and the like refer to both the singular and plural unless the context clearly indicates otherwise. “A bottle”, for example, refers to a single bottle or more than one bottle.

Also as used herein, the description of one or more method steps does not preclude the presence of additional method steps before or after the combined recited steps. Additional steps may also be intervening steps to those described. In addition, it is understood that the lettering of process steps or ingredients is a convenient means for identifying discrete activities or ingredients and the recited lettering can be arranged in any sequence.

Where a range of numbers is presented in the application, it is understood that the range includes all integers and fractions thereof between the stated range limits. A range of numbers expressly includes numbers less than the stated endpoints and those in-between the stated range. A range of from 1-3, for example, includes the integers one, two, and three as well as any fractions that reside between these integers.

As used herein, “master batch” refers to a mixture of base polymer, oxidizable organic component, and transition metal that will be diluted, typically with at least additional polyester base polymer, prior to forming an article.

The following examples are included to demonstrate preferred embodiments of the invention regarding the usefulness of a blend of a polyester base polymer, a polyolefin, a functionalized polyolefin, an oxidizable polyether-based additive, a transition metal in a positive oxidation state, and optionally a colorant as described above to make oxygen scavenging, opaque PET containers. It should be appreciated by those of skill in the art that the techniques disclosed in the examples which follow represent techniques discovered by the inventors to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### EXAMPLES

In the following examples, various compositions of PET resin blended with mixtures of oxidizable polyether-based additives, and/or transition metal catalysts were fabricated into monolayer bottles via a 2-step process. In the 1^{st} step, each composition was directly fed and melt-blended in an injection molding machine and then molded into the preforms. In a 2^{nd} step, the preforms were reheated and stretch blow molded into the final shaped containers such as bottles.

The following examples are included to demonstrate the usefulness of a blend of a polyester base polymer (PET), a polypropylene (PP) polymer as opacifying additive, an oxidizable polyether-PET copolymer as an oxygen scavenging additive (hereinafter referred to as OS additive, which also functions as compatibilizer between PET and PP) and a minor amount of a transition metal catalyst (preferably cobalt) to make clear oxygen scavenging, monolayer PET containers.

In the following examples, various compositions of PET resin blends with varying amounts of a polypropylene resin, a polyether-PET copolymer based OS additive, and/or transition metal catalyst were fabricated into monolayer bottles via a 2-step process. In the 1^{st} step, each composition was directly fed and melt-blended in an injection molding machine and then molded into the preforms. In a 2^{nd} step, the preforms were reheated and stretch blow molded into the final shaped containers such as bottles.

The monolayer preforms were made on a single cavity, 2003 Battenfeld A800/200H/125HC injection molding machine. The blended composition was fed into the throat of the injection molding extruder heated to 260-270° C. The molten blend was then injection molded into a single cavity preform mold, such as a 30 g, 33 mm finish 14 oz. ketchup bottle preform, to form the monolayer bottle preform. The cycle time for molding was about 30 sec. The preforms were then reheat-stretch-blow molded into monolayer bottles. The bottles were generally stretch blown on a Sidel SBO-1 machine set to run at a rate of ca. 800 bottles per hour. In this process, the preforms were typically heated to a surface temperature of 99° C. prior to the blowing operation. The blow mold temperature was about 12° C. The blow pressures were about 33 bar. Opaque monolayer oxygen scavenging PET bottles were thus obtained.

### Oxygen Scavenging Measurement:

The oxygen scavenging performance of all the PET bottles from these examples were evaluated using an Oxysense 4000B instrument with OxyDot oxygen sensors (available from OxySense Inc. Dallas, Tex. 752543, USA), for the measurement of oxygen ingress/oxygen content with time. Typically the OxyDots were attached to the inside middle portion of each test bottle. Each bottle is then loaded on an orbisphere bench top filler and after an initial flushing with nitrogen, it is filled with deoxygenated water (O₂ content<100 ppb) and capped. After several bottles of each composition have been filled and sealed, they were stored under ambient conditions for a required shelf-life test period while the oxygen content or ingress in the bottles is measured. To make the measurements, the fiber optic pen of the instrument was aligned with the OxyDot (from the outside of the bottle), making sure that the tip of the pen was making contact with the bottle. Then the capture button was pressed to obtain the oxygen concentration in the bottle. The oxygen concentration was measured periodically with time.

### Opacity Measurement of the Bottles:

The opacity measurement gives us an indication of how much light passes through the material comprising the wall of the PET containers. The higher the opacity, the lower the amount of light that can pass through the wall of the bottle and hence gives better shelflife for the beverage product in the bottle.

A HunterLab color measurement instrument was used to measure the opacity of the bottles. Opacity was calculated from reflectance measurements of the material (bottle wall) with a black backing and a white backing and using thee formula:

Opacity=[Y_{black backing}/Y_{white backing}]×100

### Control Example

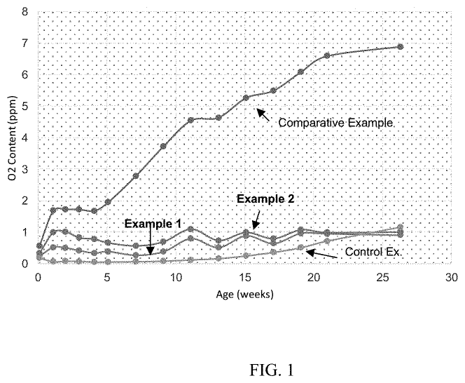

A dry blend of a commercial PET resin (Laser+HS Ti818, DAK America), herein after referred to as PET-1 was made by mixing with 1 wt % of poly(tetramethylene ether)-PET block copolymer (Oxyclear® 3500, Auriga Polymer Inc.), hereinafter referred to as “OS additive-1” and 1 wt. % of a cobalt masterbatch in PET containing ca. 1500 ppm Co (Oxyclear® 2702, Auriga Polymers) hereinafter referred to as “Co-MB.” This dry blend was directly injection molded into preforms which were subsequently blown into monolayer 14 oz. ketchup bottles (375 ml volume, 0.022 in. sidewall thickness), using the 2 step process described before. The bottles were tested for oxygen scavenging performance using the Oxysense method described earlier. The oxygen ingress data for this example is shown in FIG. 1. It may be noted that these bottles without any polypropylene added were quite clear, exhibiting very low opacity (7%).

### Comparative Example

A dry blend of PET-1 (95 w %) and 5 w % Polypropylene (Ineos R12C-00 Polypropylene Random Copolymer, Melt flow index=12 g/10 min) was made with good mixing. The blend was directly injection molded into preforms which were blown into monolayer 14 oz. ketchup bottles (375 ml volume, 0.022 in. sidewall thickness), using the 2 step process described before. The bottles were then tested for opacity using the opacity measurement method described above. The bottles showed an opacity of 76%. However as shown in FIG. 1, these comparative example bottles showed high oxygen permeation because of the absence of the oxygen scavenger additive.

### Example 1

A dry blend of PET-1 resin with 1 wt % of “OS additive-1”, 1 wt. % of Co-MB, 5 wt % Polypropylene was made. This dry blend was directly injection molded into preforms which were subsequently blown into monolayer 14 oz. ketchup bottles using the 2 step process described before. Referring to Table 1 and FIG. 1, these bottles exhibited substantial opacity (77%) compared to Control example while exhibiting good oxygen scavenging performance.

### Example 2

A dry blend of PET-1 resin with 1 wt % of “OS additive-1”, 1 wt. % of Co-MB, 10 wt % Polypropylene was made and directly injection molded into preforms which were subsequently blown into monolayer 14 oz. ketchup bottles using the 2 step process described before. Referring to Table 1 and FIG. 1, these bottles exhibited a high opacity (85%), while retaining good oxygen scavenging performance.

### Example 3

A dry blend of PET-1 resin with 1 wt % of “OS additive-1”, 1 wt. % of Co-MB, 10 wt % Polypropylene was made and directly injection molded into preforms which were subsequently blown into monolayer 14 oz. ketchup bottles using the same 2 step process described earlier. Referring to Table 1 and FIG. 1, these bottles exhibited high opacity (93%), while retaining good oxygen scavenging performance (FIG. 1)

### Example 4

A dry blend of Oxyclear® 2512 resin (a specialty PET resin 60 ppm built-in cobalt, from Auriga polymers) hereinafter referred to as “PET-2 resin”, mixed with 1 wt % of “OS additive-1” and 15 wt % Polypropylene was made and directly injection molded into preforms which were subsequently blown into monolayer 14 oz. ketchup bottles as described before. These bottles also exhibited an opacity of 85% while still retaining good oxygen scavenging.

### Example 5

PET-2 resin was blended with 20 wt % Polypropylene and 1 wt % OS additive-1 and processed into monolayer 14 oz. ketchup bottles as described before. Referring to Table 1, these oxygen scavenging opaque bottles also exhibited an opacity of 89%.

### Example 6

PET-2 resin was blended with 15 wt % Polypropylene, 1 wt % OS additive-1 and 0.5 wt % a maleic anhydride grafted Polypropylene (Sigma Aldrich, herein after referred to as PP-MA). The blend was processed into monolayer 14 oz. ketchup bottles as described before. Referring to Table 1, these bottles exhibited an opacity of 87.4%.

It is noted that compared to Example 4, this Example 6 has an additional 0.5% maleic-anhydride grafted polypropylene as compatibilizer, which is believed to improve the dispersion & increase smaller particles of PP which led an increased opacity by ca. 2.4%.

### Example 7

PET-2 resin was blended with 10 wt % Polypropylene, 0.5 wt % Terathane 1400 (Invista) which is a polytetramethylene ether of 1400MW, hereinafter referred to as (OS additive 2). The blend was processed into monolayer 14 oz. ketchup bottles as described before. Referring to Table 1, these bottles exhibited an opacity of 81.4%.

### Example 8

PET-2 resin was blended with 10 wt % Polypropylene, 0.5 wt % Terathane 2000 (Invista) which is a polytetramethylene ether of 2000MW, hereinafter referred to as (OS additive 3). The blend was processed into monolayer 14 oz. ketchup bottles as described before. Referring to Table 1, these bottles exhibited an opacity of 86%.

### Comparative Example A

PET-2 resin was blended with 15 wt % Polypropylene, 0.5 wt % PP-MA and was processed into monolayer 14 oz Ketchup bottles by the 2-step process described before. The bottles showed an opacity of 81.5%.

It is noted that this comparative example has the same 15 w % PP and 0.5 w % PP-MA as in Example 6 but does not include 1% OS-1 additive. Hence it has lower opacity (81.5%) compared to Example 6 which has 87.4% opacity. Without intending to be bound by a particular theory, it is believed that the OS-1 (polyether-b-PET) additive acts also as a compatibilizer to improve the dispersion of PP & increase the number of smaller particles of PP which may account for an increase of opacity by 5.9%.

TABLE 1
Opacity values of O₂ scavenging PET-PP blend' bottles (0.02″ wall
thickness) of this invention
(All percentages shown are by wt %)

| Bottle | Composition | Y Opacity |
|---|---|---|
| Control Ex. | PET-1 + 1% OS additive-1 + 1% Co-MB | 7 |
| Comp. Ex. | PET-1 + 5% PP | 76 |
| Comp. Ex. ‘A’ | PET-2 + 15% PP + 0.5% PP-MA | 81.5 |
| Ex. 1 | PET-1 + 1% OS additive-1 + 1% Co-MB + | 77 |
| | 5% PP | |
| Ex. 2 | PET-1 + 1% OS additive-1 + 1% Co-MB + | 85 |
| | 10% PP | |
| EX. 3 | PET-1 + 1% OS additive-1 + 1% Co-MB + | 93 |
| | 15% PP | |
| Ex. 4 | PET-2 + 1% OS additive-1 + 15% PP | 85 |
| Ex. 5 | PET-2 + 1% OS additive-1 + 20% PP | 89 |
| Ex. 6 | PET-2 + 1% OS additive-1 + 15% PP + | 87.4 |
| | 0.5% PP-MA | |
| Ex. 7 | PET-2 + 0.5% OS additve-2 + 10% PP | 81.4 |
| Ex. 8 | PET-2 + 0.5% OS additve-3 + 10% PP | 86 |

The foregoing examples and description of the preferred embodiments should be taken as illustrating, rather than as limiting the present invention as defined by the claims. As will be readily appreciated, numerous variations and combinations of the features set forth above can be utilized without departing from the present invention as set forth in the claims. Such variations are not regarded as a departure from the spirit and scope of the invention, and all such variations are intended to be included within the scope of the following claims.

We claim:

1. A wall for a container comprising a composition wherein the composition comprises:
a polyester base polymer;
a polyolefin polymer;
a functionalized polyolefin polymer selected from the group consisting of a maleic anhdride-grafted polypropylene, a maleic anhydride-grafted polypropylene adhesive resin, an acrylic acid-grafted polyproylene, a maleic anhydride-grafted styrene-ethylene-butylene-styrene copolymer, an ethylene-butyl acrylate-maleic anhydride terpolymer, an ethylene-butyl acrylate-glycidyl methacrylate terpolymer, an oxidized polyethylene wax, and mixtures thereof;
an oxidizable polyether-based additive; and
a transition metal catalyst.

2. The wall of claim 1 further comprising a colorant.

3. The wall of claim 2 wherein the colorant comprises TiO₂.

4. The wall of claim 1, wherein the polyester base polymer is polyethylene terephthalate.

5. The wall of claim 1, wherein the oxidizable polyether-based additive has the formula X—[R—O]ₙ—R′—Y, wherein
R is a substituted or unsubstituted alkylene chain having from 2 to 10 carbon atoms;
n ranges from 4 to 100;
X and Y are selected from the group consisting of H, OH, —OCOR₁, —OCOAr₁, —OR₁, and —OAr₁, wherein R₁ is an alkyl group having from 2 to 18 carbon atoms and Ar₁ is an aryl group; and
R′ may be the same as R or selected from the group consisting of — [COR₂COOR₃O]ₚ— and — [COAr₂COOR₃O]ₚ— wherein Ar₂ is a phenylene or naphthylene group, R₂ and R₃ are C₂ to C₁₈ alkylene groups, and p ranges from 10 to 100.

6. The wall of claim 1, wherein the oxidizable polyether-based additive is selected from the group consisting of polyether diols, ester capped derivatives of polyether diols, polyether-polyester block copolymers, and ether end-capped ether end-capped derivatives of polyether diols.

7. The wall of claim 6, wherein the oxidizable polyether-based additive comprises polytetramethylene ether glycol.

8. The wall of claim 6, wherein the oxidizable polyether-based additive comprises polytetramethylene ether glycol dibenzoate or polytetramethylene ether glycol dioctaoate.

9. The wall of claim 6, wherein the oxidizable polyether-based additive comprises PTMEG-b-PET copolymer.

10. The wall of claim 6, wherein the oxidizable polyether-based additive comprises polytetramethylene ether glycol dimethyl ether.

11. The wall of claim 1, wherein the transition metal catalyst comprises cobalt.

12. The wall of claim 11 wherein the cobalt is present in the polyester base polymer.

13. The wall of claim 1, wherein the transition metal catalyst comprises a carboxylate salt.

14. The wall of claim 1, wherein the transition metal catalyst comprises cobalt neodecanoate.

15. The wall of claim 1, wherein the polyester base polymer contains less than 10 ppm of antimony.

16. The wall of claim 15, wherein the polyester base polymer contains less than 40 ppm of phosphorous.

17. The wall of claim 1 wherein the wall exhibits a light transmittance of less than about 1.0% at a wavelength of from about 400 nm to about 700 nm.

18. A wall for a container comprising a composition wherein the composition comprises:
a polyester base polymer;
from about 5 wt. % to about 15 wt. % of a polyolefin polymer;
from about 0.1 wt. % to about 1.5 wt. % of a functionalized polyolefin polymer selected from the group consisting of a maleic anhdride-grafted polypropylene, a maleic anhydride-grafted polypropylene adhesive resin, an acrylic acid-grafted polyproylene, a maleic anhydride-grafted styrene-ethylene-butylene-styrene copolymer, an ethylene-butyl acrylate-maleic anhydride terpolymer, an ethylene-butyl acrylate-glycidyl methacrylate terpolymer, an oxidized polyethylene wax, and mixtures thereof;
from about 0.5 wt. % to about 5 wt. % of an oxidizable polyether-based additive;
a transition metal catalyst; and
from about 1 wt. % to about 3 wt. % of a colorant.

19. The wall of claim 18 wherein the colorant comprises TiO₂.

20. The wall of claim 18, wherein the polyester base polymer is polyethylene terephthalate.

21. The wall of claim 18, wherein the oxidizable polyether-based additive has the formula X—[R—O]ₙ—R′—Y, wherein
R is a substituted or unsubstituted alkylene chain having from 2 to 10 carbon atoms;
n ranges from 4 to 100;
X and Y are selected from the group consisting of H, OH, —OCOR₁, —OCOAr₁, —OR₁, and —OAr₁, wherein R₁ is an alkyl group having from 2 to 18 carbon atoms and Ar₁ is an aryl group; and
R′ may be the same as R or selected from the group consisting of — [COR₂COOR₃O]ₚ— and — [COAr₂COOR₃O]ₚ— wherein Ar₂ is a phenylene or naphthylene group, R₂ and R₃ are C₂ to C₁₈ alkylene groups, and p ranges from 10 to 100.

22. The wall of claim 18, wherein the oxidizable polyether-based additive is selected from the group consisting of polyether diols, ester capped derivatives of polyether diols, polyether-polyester block copolymers, and ether end-capped ether end-capped derivatives of polyether diols.

23. The wall of claim 22, wherein the oxidizable polyether-based additive comprises polytetramethylene ether glycol.

24. The wall of claim 22, wherein the oxidizable polyether-based additive comprises polytetramethylene ether glycol dibenzoate or polytetramethylene ether glycol dioctaoate.

25. The wall of claim 22, wherein the oxidizable polyether-based additive comprises PTMEG-b-PET copolymer.

26. The wall of claim 22, wherein the oxidizable polyether-based additive comprises polytetramethylene ether glycol dimethyl ether.

27. The wall of claim 18, wherein the transition metal catalyst comprises cobalt.

28. The wall of claim 27 wherein the cobalt is present in the polyester base polymer.

29. The wall of claim 18, wherein the transition metal catalyst comprises a carboxylate salt.

30. The wall of claim 18, wherein the transition metal catalyst comprises cobalt neodecanoate.

31. The wall of claim 18, wherein the polyester base polymer contains less than 10 ppm of antimony.

32. The wall of claim 31, wherein the polyester base polymer contains less than 40 ppm of phosphorous.

33. The wall of claim 18 wherein the wall exhibits a light transmittance of less than about 1.0% at a wavelength of from about 400 nm to about 700 nm.
